(19) United States
(12) Patent Application Publication
(10) Pub. No.: US 2005/0238188 A1
(43) Pub. Date: Oct. 27, 2005

(54) Optical microphone transducer with methods for changing and controlling frequency and harmonic content of the output signal

(76) Inventor: Peter Ray Wilcox, Glendale, AZ (US)

Correspondence Address: Peter Ray Wilcox, 5317 W. Monte Cristo Ave., Glendale, AZ, 85306, US

(21) Appl. No.: 10/833,661

(22) Filed: Apr. 27, 2004

(51) Int. Cl. H04B 10/02; H01J 1/56; G01D 5/34

(52) U.S. Cl. 381/172; 250/229; 250/221

(57) ABSTRACT

A reflective optical position or object detector, containing a light source (LED) and detector (phototransistor) is placed proximate to an acoustic membrane such that the output of the detector produces an electric signal corresponding to the motion of the membrane toward and away from the detector. Groups of these detectors can be placed at different locations under a single membrane to reproduce the frequency and harmonic content of the motion of the membrane at those locations, and the signals from each can be combined in variable proportion to a resultant electrical signal. These groups can be bounded by isolating frames and several bounded groups can be placed under a single membrane, or be covered by separate membranes. The groups with their bounding frames can be moved toward or away from the membrane, placing more or less tension upon the membrane, thereby altering the harmonic and frequency content of its vibration.

### BACKGROUND OF THE INVENTION

The present invention is related generally to transducers, devices that transform energy received of one kind into energy transmitted of a second kind. This invention relates to a transducer which responds to acoustic or mechanical energy and transforms the information in this energy first into optical signals, which are then transformed in turn into electrical signals,

This invention also relates to microphone capsules, and the difficulty in transforming the acoustic information into corresponding electrical information in such a fashion that the electrical information, when subsequently transformed back into acoustic energy, by means of an amplifier/speaker system, closely or exactly resembles the original sound, or has other desirable frequency and harmonic content which may not resemble the original sound. Many types of transducers are used in the art of recording sound, including condenser (capacitor), ribbon, dynamic (moving coil), and others, and all need various methods of tuning or other frequency shaping in their manufacture, not manipulable by the end user, to modify the resultant electrical signal to produce the desired effect.

The present invention uses one or more small optical transducers in a configuration that allows the selection, by the user, of various frequencies and harmonics from one or more acoustic membranes, which also can be tuned by varying the tension placed upon them, and the mixing or combining in varying amounts of the resultant electrical signals into the output signal or signals.

The present invention differs from the prior art in that:
1) It does not use optical fibers or other types of wave or light guides
2) It does not use a knife edge or other method of blocking part of the light from reaching the membrane or detector
3) It does not use separate light emitters and detectors, but rather an integrated device containing both emitter and detector
4) It uses varying distance from the emitter-detector to the membrane to modify the output current, rather than lateral displacement of a light beam
5) The emitter-detector units are of such a small size that multiple units can be placed at various locations under a single membrane
6) Variable tension can be placed upon the membrane to “tune” or otherwise alter the frequency or harmonic content of the output signal
7) Several units of differing size or shape, each with its own membrane of possibly differing thickness or other damping factor, can be placed on a singe base substrate

### BRIEF SUMMARY OF THE INVENTION

It is the object of the present invention to provide a new type of microphone transducer or capsule, which, by transforming acoustic energy into light energy, and thence into one or several electrical signals differing in harmonic content, can, by combining one or more of the resultant electrical signals in various amounts into one resultant signal, which when transformed back into sound, produce controlled amounts of harmonic content

The present invention uses one or more reflective optical position or object detectors as transducers in a configuration that allows the selection, by the user, of various frequencies and harmonics from one or more acoustic membranes, which also can be tuned by varying the tension placed upon them, and the mixing or combining in varying amounts of the resultant electrical signals into the output signal or signals.

That is, in simple terms, the invention provides a microphone capsule or transducer whose output of frequency and harmonic content can be manipulated at will and in reproducible, controlled amounts, by the user.

Additionally, this microphone capsule will not have the historically difficult coupling characteristics to further amplification circuits, such as the extremely high impedance circuitry of condenser capsules, or the extremely low impedance of the ribbon transducer. The signal from this capsule can be amplified by common bipolar transistor or operational amplifier circuits.

### BRIEF DESCRIPTION OF THE SEVERAL VIEWS OF THE DRAWING

FIG. 1 is a functional diagram of the basic transducer unit, the reflective optical position sensor, in its elementary form, showing the mechanism of conversion of acoustic signals to electrical signals.

FIG. 2 illustrates the first embodiment of the invention showing multiple reflective optical position sensors and the mixing electronic block diagram for combining the signals.

FIG. 3 illustrates this same embodiment with a mechanism for variable tension applied to the membrane.

FIG. 4 illustrates the second embodiment of the invention, with separate frames attached to the base substrate.

FIG. 5 is a three dimensional representation of FIG. 4 without the acoustic membrane.

FIG. 6 is a three dimensional representation if FIG. 4 showing the membrane overlying.

FIG. 7 illustrates the second embodiment of the invention, with a mechanism for variable tension applied to the membrane.

FIG. 8 illustrates the third embodiment of the invention, with separate membranes attached to separate frames, which are attached to the base substrate.

FIG. 9 is a three dimensional representation of FIG. 8.

FIG. 10 is a graph of an electrical property of a reflective optical position sensor, illustrating the collector current as a function of distance from the membrane.

### DETAILED DESCRIPTION OF THE INVENTION

In referring to numbered parts of the figures of the drawing, like numerals will be used to refer to identical parts of the apparatus.

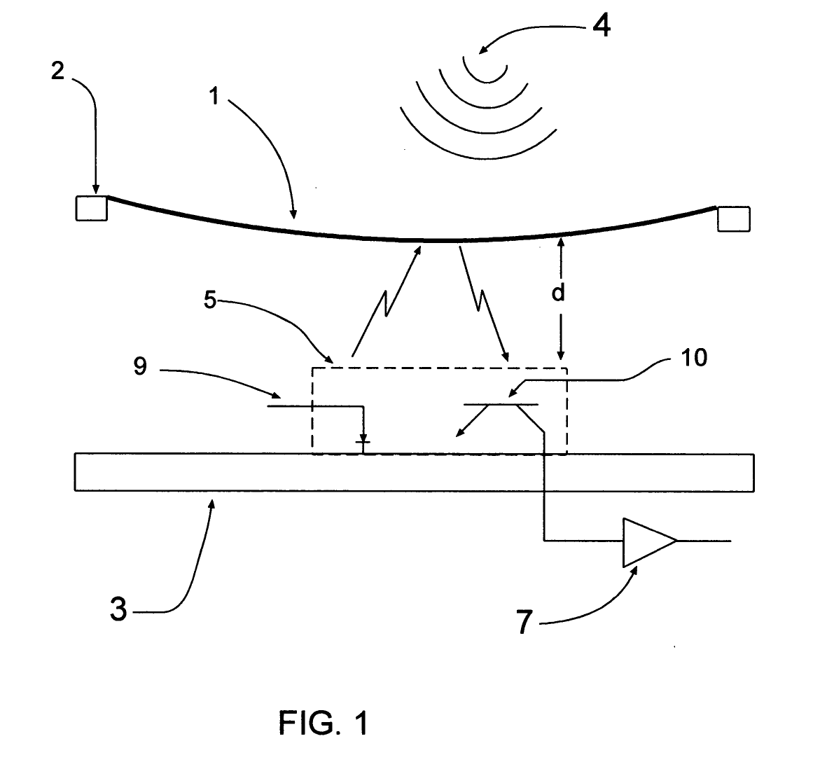

FIG. 1 shows a diagram of the general building block of the transducer in its elementary form. Acoustic signals 4 impinge upon a membrane 1 (which may be plano, concave, convex, ribbed, corrugated or of other deformation), held in place over a bounding frame 2, which may be of any shape appropriate (circular, elliptical, polygonal, ribbon or other), causing the membrane to vibrate mechanically in response. This membrane may also have damping materials affixed to it in one or more locations to vary the frequency and harmonic content of its vibration.

A reflective position emitter-sensor 5 (hereafter known as an “optosensor”) is affixed to base 3, which may be solid or may have an aperture or apertures cut into it to allow the passage of acoustic signals from the back, and which may be a printed circuit board, and the sensor may be electrically connected to conductive pathways upon it. Electromagnetic energy, such as visible or infrared light is propagated from light-emitting diode (LED) 9 toward the surface of membrane 1. This light is reflected off the membrane and detected by phototransistor 10, producing an electric current. This current is sent to circuit 7, where by any of numerous known methods it is converted to an appropriate voltage for further mixing, amplification or other possible manipulation before being routed to a microphone preamplifier.

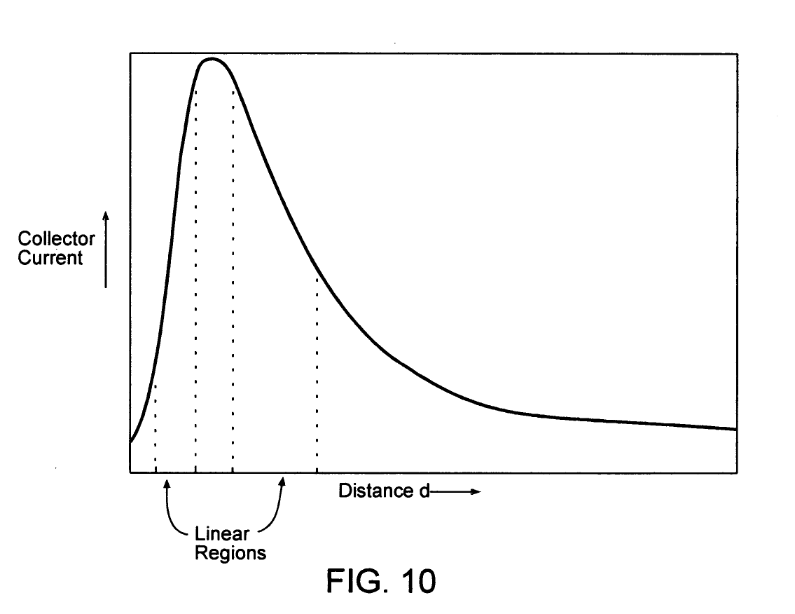

As the membrane 1 vibrates in response to the acoustic signal, distance d from the sensor to the membrane increases and decreases, causing the output of the optosensor to vary in response to this change in distance according to the graph in FIG. 10, producing a varying electric current in direct proportion to the movement of the membrane 1, when this distance d is in the range to cause the output current to fall in one of the linear areas depicted in FIG. 10.

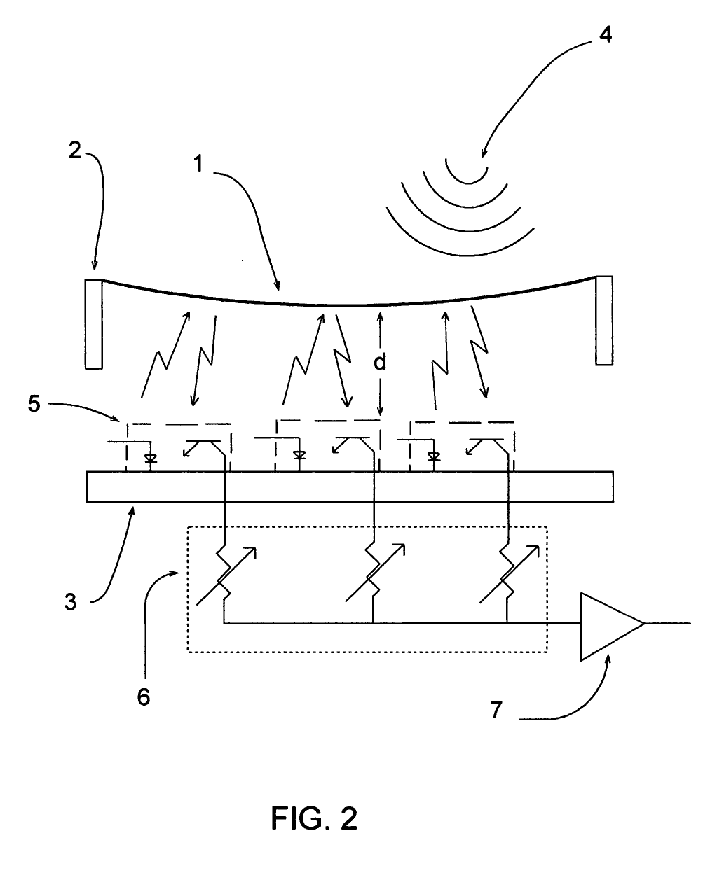

FIG. 2 illustrates a block diagram the first embodiment of the invention. Membrane 1, frame 2 and base substrate 3 are as in FIG. 1. Two or more reflective optosensors 5 are mounted upon the base and maintained at distance d from the acoustic membrane.

The electrical current outputs of these two or more optosensors are fed to resistances 6. These resistors are variable, and can pass user-determined amounts of the signals from each sensor. These resistors can take the form of potentiometers, variable resistors, voltage controlled amplifiers or other voltage dependent device such as a FET, digitally controlled amplifiers or other like devices. These several signals from the resistors are then passed to a summing amplifier 7 or other summing, mixing or combining circuit or device, where they are combined and output as a single signal or multiple signals.

This summation signal will then be comprised of varying frequencies, depending upon which frequencies and harmonics are present in the portions of the acoustic membrane overlying each sensor, and according to the amount of attenuation they have received through the resistances 6.

This signal can then be manipulated by any of various known methods to a level acceptable to standard microphone preamplifiers.

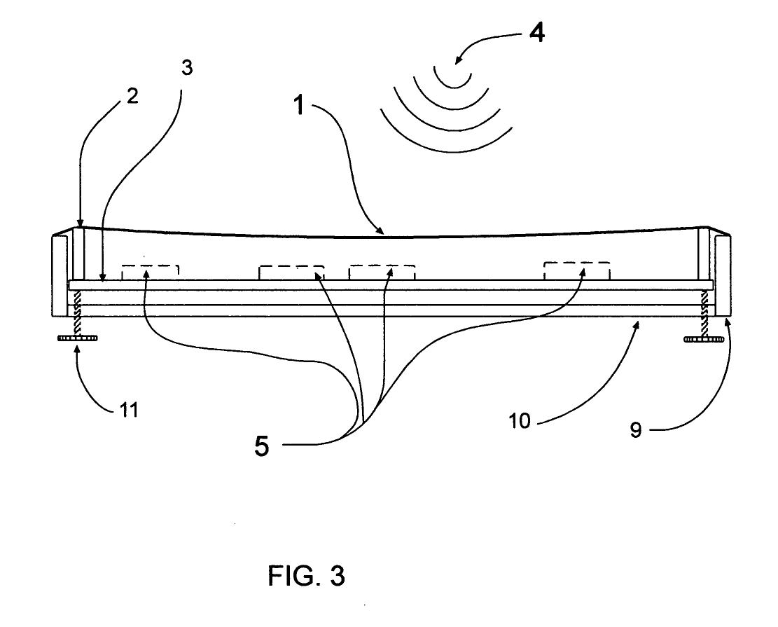

FIG. 3 illustrates a mechanism for variably tensioning or tuning the membrane, whereby the base substrate carrying the bounding frame and optosensors is placed within a second bounding frame 9 and its base substrate 10, and may move freely within it, by means of thumb screws 11 or by other means, toward and away from the membrane 1 which is attached throughout its periphery to the bounding frame 9.

This movement places varying amounts of tension upon the membrane, thereby altering its response to the acoustic wave, and varying the acoustic frequency and harmonic content of the membrane's vibration.

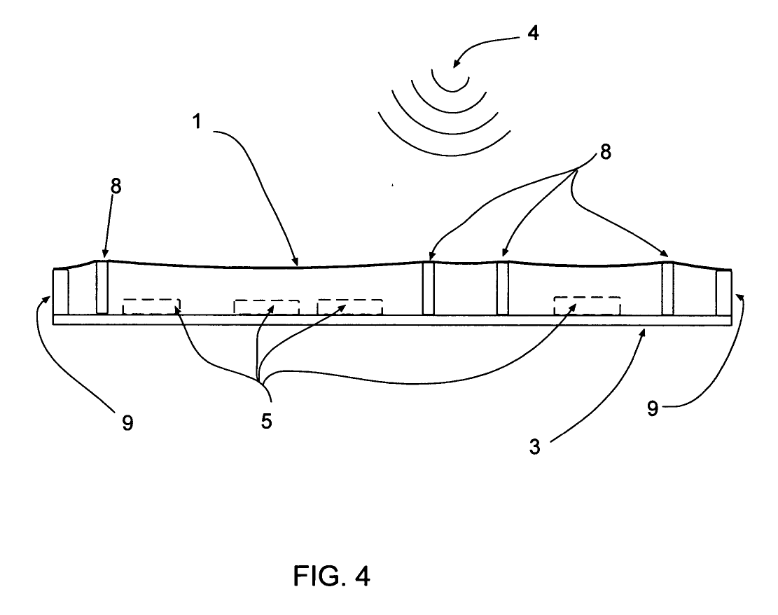

FIG. 4 illustrates a second embodiment of the invention, where two or more groups of one or more sensors 5 are bounded by separate bounding frames 8, each of which impinge upon areas of the membrane overlying them, having the effect of creating separate vibrating areas responsive to different frequencies and harmonics. Electrical outputs from each of the sensors can then be mixed with those from its own group, or with those of other individual sensors or groups of sensors, to form the resultant signal.

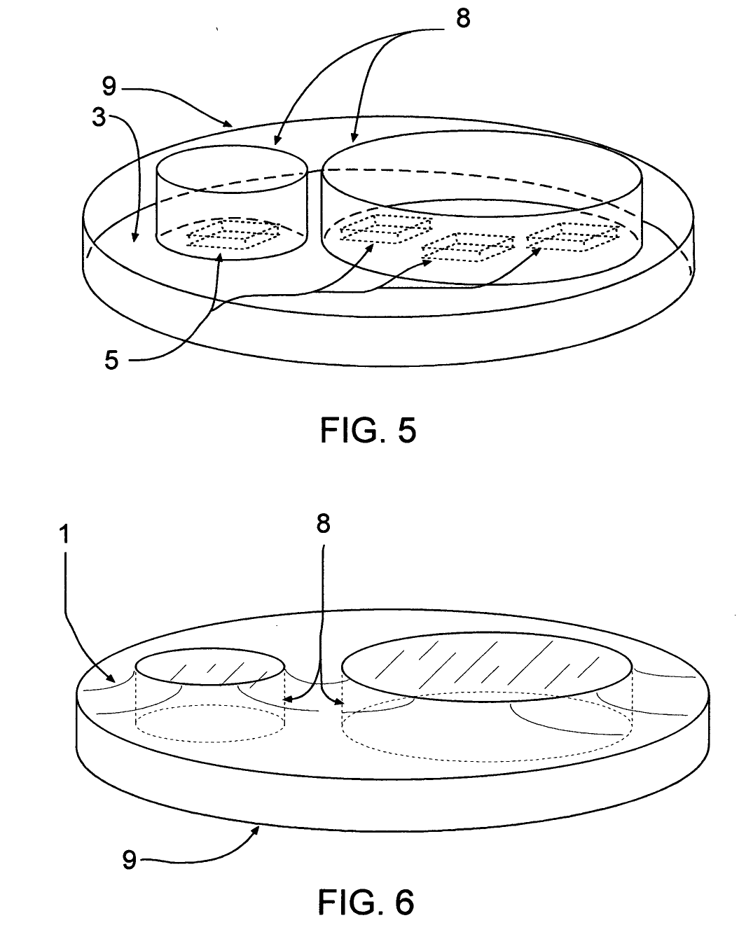

FIG. 5 is a three dimensional representation of the second embodiment of FIG. 4, illustrating in this case circular bounding frames 8 enclosing the sensors 5 upon the substrate 3.

FIG. 6 is the same illustration as FIG. 5, showing the overlying acoustic membrane 1.

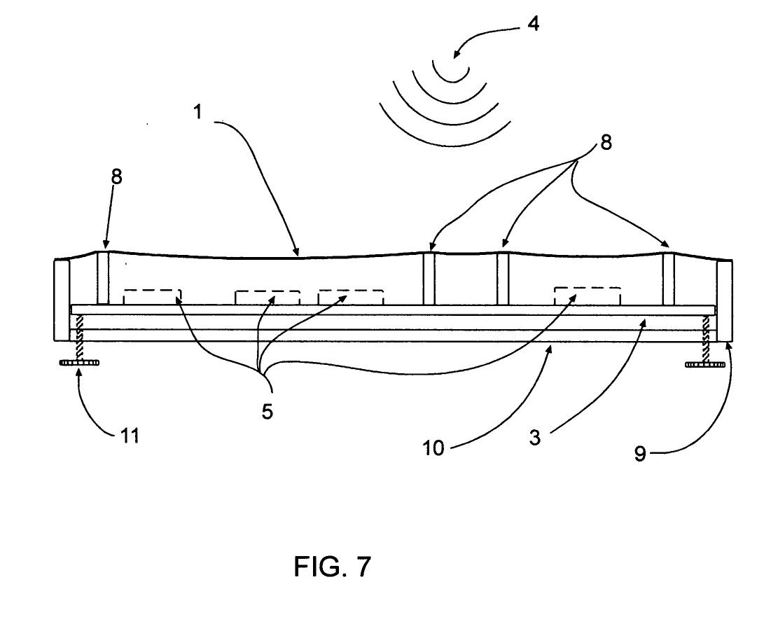

FIG. 7 illustrates a method of variably tensioning the second embodiment, similarly to that in FIG. 3.

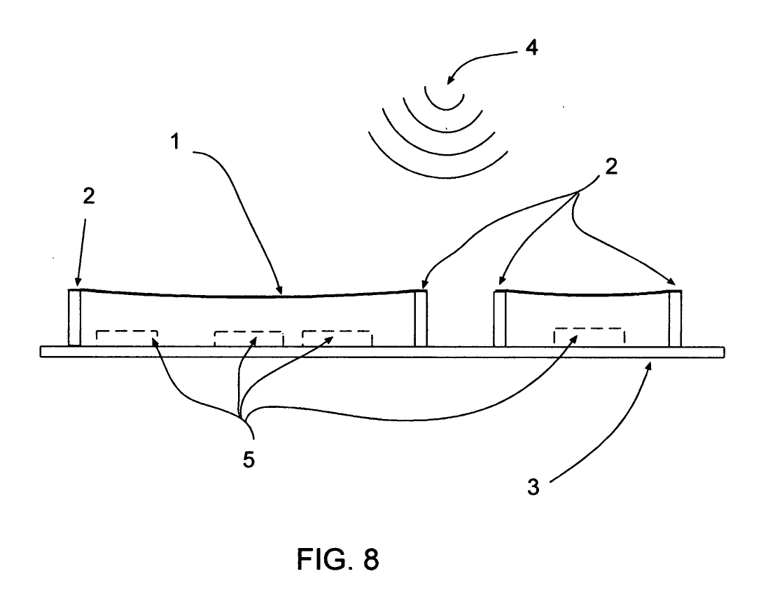

FIG. 8 illustrates the third embodiment of the invention, showing the membranes 1 as separate entities and attached each to the bounding frames 2 separating each group of sensors 5, with the bounding frames 2 affixed to base substrate 3.

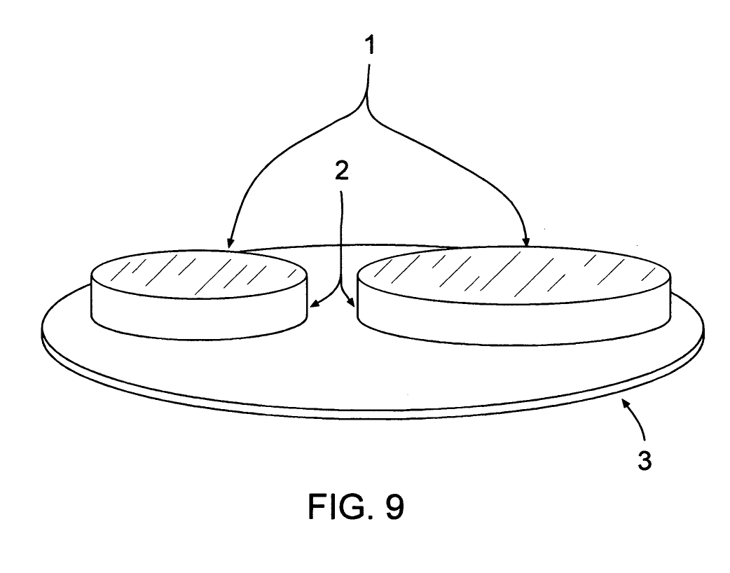

FIG. 9 is a three dimensional representation of the third embodiment of the invention illustrated in FIG. 8, illustrating the bounding frames 2 affixed to base substrate 3, with acoustic membranes 1 affixed to the frames.

FIG. 10 is a graph of the pertinent operative property of an optoreflective emitter-sensor, (such as Fairchild QRE1113, Vishay TCNT1000, or Marktech MTRS9520), illustrating the collector current as a function of distance from the membrane. This current varies in intensity as the membrane increases or decreases its distance from the photosensitive device as it responds to the acoustic signal. This variation is approximately linear when the distance d falls within the regions described as “Linear Regions.”

1) A reflective object sensor, in which are integrated an electromagnetic (light) source such as an LED, and a photosensitive device, such as a phototransistor, (many of which are currently available as position sensors such as Fairchild QRE1113, Vishay TCNT1000, or Marktech MTRS9520, or of which may be made available in the future specifically optimized for the use described herein, either as single devices or in the form of an array on a common substrate) is mounted or placed under a reflective (not necessarily specular) membrane, (which may be piano, concave, convex, ribbed, corrugated or of other deformation, and which can take one of many shapes—circular, elliptical, polygonal, ribbon, and which may vary in thickness or have damping materials affixed to it to alter the frequencies or harmonics of its vibration), which moves in response to acoustic waves impinging upon it, in such a manner that the reflected electromagnetic (light) signal is captured by the photosensitive element in its linear region with respect to distance from the membrane, generating an electrical signal which varies in intensity as the membrane increases or decreases its distance from the photosensitive device as it responds to the acoustic signal.

2) Two or more of these devices, or an array of these devices, are mounted or placed on a substrate in proximity to the membrane, at varying distances from the geometric center axis of the membrane and possibly including the geometric center axis, and each device will respond to and generate an electrical signal corresponding to the particular frequencies and harmonics generated by the membrane at that location.

3) These two or more electrical signals will then be combined, summed or mixed to a single signal which is the output of the circuit, and the combination of these signals can be effected and varied through analog means, such as potentiometers, variable resistors or voltage controlled amplification, or by a combination of analog and digital means, such as digitally controlled amplification, or by analog to digital conversion and further combination and processing in the digital realm.

4) In a second embodiment of the invention, one or more of these sensors on the base substrate may be bounded or encircled by a frame, which frame may be of any circular or polygonai shape, and which impinges upon the membrane, thus isolating the movement of that portion of the membrane from the rest of the membrane, and there may be one or more of these bounded units on the base substrate.

5) The outputs of each of these units can be mixed with outputs from the others to yield an electrical signal containing the desired frequencies and harmonics.

6) The tension or force of the impingement of these bounding frames on the membrane can also be varied by mechanical means, such as thumbscrews or other method of moving the base substrate toward or away from the membrane, thereby allowing the membrane to be tuned to respond differentially to various frequencies.

7) In a third embodiment of the invention, there can be a multiplicity of membrane units as described in claim #2, each set upon the same base foundation, each with one or more reflective sensors of the same or different sizes set under it, and with the outputs of the sensors mixed as in claim #3.
